(19) United States
(12) Patent Application Publication
(10) Pub. No.: US 2022/0309461 A1
(43) Pub. Date: Sep. 29, 2022

(54) SYSTEMS AND METHODS FOR REAL-TIME PAYMENT ON DELIVERY

(71) Applicant: JPMORGAN CHASE BANK, N.A., New York, NY (US)

(72) Inventors: Liv Nakamura WANG, Jersey City, NJ (US); S Richard RE, Westfield, NJ (US); Ana GARCIA, East Hanover, NJ (US); William Gregory KERWICK, III, Jersey City, NJ (US); Kimberly A KEELY, Spring Hill, FL (US); Sofia FREYDER, Jersey City, NJ (US); Rachel S DOMINGO, Clifton, NJ (US)

(21) Appl. No.: 17/214,638

(22) Filed: Mar. 26, 2021

(51) Int. Cl. G06Q 10/08; G06Q 10/06; G06Q 20/08; G06Q 30/04; G06Q 20/40; G06Q 10/04; G06N 20/00

(52) U.S. Cl. CPC G06Q 10/08355; G06Q 10/06315; G06Q 10/0833; G06Q 20/085; G06Q 30/04; G06Q 20/4037; G06Q 10/0875; G06Q 10/047; G06Q 20/407; G06N 20/00; G06Q 40/02

(57) ABSTRACT

Systems and methods for real-time payment on delivery via a request for payment are disclosed. In one embodiment, a method may include: receiving, at a merchant application associated with a merchant, an order for a good to be submitted to a distributor; communicating, to a payment on demand (POD) application executed by a backend, the order; receiving, at the merchant application and from the POD application, a notification that a delivery vehicle for the good is en route to a merchant location; receiving, at the merchant application and from the POD application, a request for payment for the good after the good is delivered, wherein the distributor confirms delivery with the POD application; and communicating, by the merchant application and to the POD application, receipt of the good from the distributor; wherein the POD application executes payment for the good from a merchant account to a distributor account.

### BACKGROUND OF THE INVENTION

### 1. Field of the Invention

Embodiments are generally directed to systems and methods for real-time payment on delivery.

### 2. Description of the Related Art

Payment on delivery is a popular but inflexible way of paying for a good or service. For example, when a good or service is delivered, the recipient pays for the good or service. This allows the recipient to confirm that the goods or services are acceptable before making payment.

### SUMMARY OF THE INVENTION

Systems and methods for real-time payment on delivery via a request for payment are disclosed. In one embodiment, a method for real-time payment on delivery may include: (1) receiving, at a merchant computer program executed by a merchant electronic device associated with a merchant, an order for a good to be submitted to a distributor; (2) communicating, to a payment on demand computer program executed by a backend, the order; (3) receiving, at the merchant computer program and from the payment on demand computer program, a notification that a delivery vehicle for the good is en route to a location for the merchant; (4) receiving, at the merchant computer program and from the payment on demand computer program, a request for payment for the good after the good is delivered, the distributor confirms delivery with the payment on demand computer program; and (5) communicating, by the merchant computer program and to the payment on demand computer program, receipt of the good from the distributor; wherein the payment on demand computer program executes payment for the good from a merchant account to a distributor account.

In one embodiment, the order may be a one-time order, a standing order, etc.

In one embodiment, the method may further include communicating, by the merchant computer program and to the payment on demand computer program, a modification the order after receiving the notification that the delivery vehicle is en route. The payment on demand computer program may verify that the distributor can meet the modification and may modify an invoice based on the modification and communicates the modified invoice to the merchant computer program after receiving confirmation of delivery.

In one embodiment, the payment may be executed using a payment on demand payment network.

In one embodiment, the merchant account may have a minimum funding requirement, and the payment on demand computer program may verify that the merchant account meets the minimum funding requirement before the delivery vehicle is en route to the merchant location.

According to another embodiment, a method for real-time payment on delivery may include: (1) receiving, at a distributor computer program executed by a distributor electronic device and from a payment on demand computer program executed by a backend, an order for a good from a merchant computer program; (2) validating, by the distributor computer program, the order against a distributor inventory of the good; (3) receiving, at the distributor computer program and from the payment on demand computer program, an instruction to prepare the good for delivery; (4) generating, by the distributor computer program, a route for a delivery vehicle carrying the good; (5) receiving, at the distributor computer program, a confirmation of delivery of the good; and (6) communicating, by the distributor computer program and to the payment on demand computer program, the confirmation of delivery.

In one embodiment, the method may further include receiving, by the distributor computer program, a payment from the merchant; and communicating, by the distributor computer program and to the payment on demand computer program, the payment.

In one embodiment, the step of generating, by the distributor computer program, a route for a delivery vehicle carrying the good may include optimizing, by the distributor computer program, the route to minimize at least one of time, distance, backtracking, time in traffic.

In one embodiment, the method may further include receiving, by the distributor computer program and from the payment on demand computer program, a modification to the order. The distributor computer program may communicate confirmation of delivery of the modified order to the payment on demand computer program.

In one embodiment, the method may further include sending, by the distributor computer program, the route to a driver computer program executed by a driver electronic device or the delivery vehicle.

In one embodiment, the method may further include receiving, by the distributor computer program, an indication of payment from the merchant, and communicating, by the distributor computer program, the indication of payment to the payment to the payment on demand computer program.

In one embodiment, the indication of payment may include a credit card payment, an image of a check, etc.

According to another embodiment, a method for real-time payment on delivery may include: (1) receiving, at a payment on demand computer program executed by a backend, a delivery notification from a distributor computer application or a driver computer application indicating that a good was delivered to a merchant; (2) generating, by the payment on demand computer program, a request for payment from the merchant; (3) communicating, by the payment on demand computer program, the request for payment to a merchant computer application for the merchant; (4) receiving, from the merchant computer application, confirmation of payment; and (5) causing, by the payment on demand computer program, the payment to be executed from a merchant account to a distributor account.

In one embodiment, the payment may be executed using a payment on demand payment network.

In one embodiment, the merchant account has a minimum funding requirement, and the payment on demand computer program verifies that the merchant account meets the minimum funding requirement.

In one embodiment, the method may further include receiving, by the payment on demand computer program, an indication that the good was unacceptable; generating, by the payment on demand computer program, a discount or refund for the unacceptable good; and crediting, by the payment on demand computer program, the account for the merchant with the discount or refund.

In one embodiment, the indication that the good was unacceptable may include an image of the good, and the discount or refund may be based on an assessment provided by trained machine-learning model.

In one embodiment, the method may further include updating, by the payment on demand computer program, an inventor for the distributor following delivery.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a depicts a system for real-time payment on delivery via a request for payment according to an embodiment;

FIG. 2 depicts a method for real-time payment on delivery according to an embodiment;

FIG. 3 depicts a method for real-time payment on delivery according to another embodiment; and

FIG. 4 depicts a method for real-time payment on delivery according to another embodiment.

### DETAILED DESCRIPTION OF PREFERRED EMBODIMENTS

Embodiments are directed to systems and methods for real-time payment on delivery.

Embodiments may facilitate the creation or modification of an existing purchase order. For example, using a computer program or application, a merchant may modify an existing standing purchase order (e.g., a recurring weekly delivery) to accommodate to their customers' demands. So long that these changes are done before a cutoff time, they will receive their order in a timely manner.

Embodiments may provide a distributor with a list of scheduled deliveries/invoices. For example, the may be provided with an overview for the day's scheduled deliveries and, using a computer program or application, can click through each delivery for more information. Details may include a client overview (e.g., who the client is and any notes the distributor may have added), address, contact information, order details, etc. Each client may have client profile, which may include the client information.

Embodiments may provide a navigation system that, by integrating with a third-party navigation system, efficiently routes the driver to the different delivery addresses. Once the delivery is marked as complete, the navigation begins the route for the next destination. The merchant, using the computer application or program, may track the estimated time of arrival, or ETA, for its deliveries in real-time. If there are delays/traffic jams, the ETA is updated accordingly. The application may not provide the driver's exact location until the driver is en route to the merchant. The merchant may be alerted once the distributor has arrived at the destination.

Embodiments may provide adjustable invoices. For example, a merchant may make changes to its order at the time of delivery. The computer program or application may be integrated with the distributor's inventory and may account for available inventory. Changes to the invoice may be saved in archive/history, so that the merchant and distributor can refer to it as needed.

Embodiments may inventory management for distributors. The computer application or program may be integrated with the distributor's inventory management system; thus, the distributor or driver may add/remove items from an order and keep track of their inventory's availability. Inventory may be updated once the merchant receives its deliveries from the distributor; updates may be made in real-time.

In one embodiment, a distributed ledger network, such as a blockchain-based network, may provide inventory management functionality.

Embodiments may facilitate payment requests to the merchant. For example, a payment request that is received by the merchant may be enabled through the REAL-TIME PAYMENTS network, the FED NOW payment network, etc. Other payment methods are may be used as is necessary and/or desired.

In embodiments, the merchant may make partial payments. Partial payments made by the merchant may refers to one invoice may be referenced by the distributor.

The distributor/merchant may also cancel the payment request if needed.

The distributor may have the merchant's bank account information, or other contact information (e.g., phone number, email address, or any other suitable alias).

In embodiment, the distributor may initiate a payment request via a machine-readable code, such as a QR code.

If the merchant chooses to pay with cash/check, an option may be provided to mark the request for payment as completed and paid with cash/check. In embodiments, the computer program or application may provide check depositing functionality.

In embodiments, the distributor and/or merchant may add notes/comments to the payment request, for their reference. The comments may be saved as is necessary and/or desired.

In embodiment, an invoice may be attached to a payment request. In one embodiment, the merchant may also opt to also receive the invoices through e-mail or mailed at the end of the month, or at any suitable time.

Embodiments may provide notifications for payment requests. For example, the merchant/merchant back-office may receive a notification of a new and pending RFP from the distributor. The distributor may be notified once the merchant completes the payment. Notifications may be app-based (e.g., in-app messaging), SMS-based, email-based, etc. based on the user's preference. The e-mail/phone number may be associated with the user's profile on the computer program or application for the user to properly receive notifications.

In embodiments, distributors may receive notifications when payment has been completed.

In embodiments, distributors and merchants may configure which notifications they want to receive through the computer program or application.

In embodiments, a payment request user interface may be provided. The merchant may either receive the payment request via its computer program or application or through a banking portal.

In embodiments, the computer program or application may be integrated with the merchant's banking portal, and the merchant can view the payment request through the portal.

In embodiments, because the payments leverage the RTP payment rails, funds may be disbursed immediately into the creditor's account, and debited immediately from the debtor's account.

Embodiments may provide ERP and TMS Integration: The merchant and/or distributor may have their ERPs/TMSs integrated with the pay-on-demand platform. For example, the distributor and/or the merchant may review all past, current, and future orders in their online portal (desktop, web, mobile, tablet, etc.). The payments made are irrevocable, but users may send payment requests regarding a past order if required (such as when there is a product recall, product was more damaged than expected, etc.).

Embodiments may provide earn wage collection: The distributor employee making the deliveries may also use the computer program or application to collect their earned wages. These earned funds may be disbursed in real-time to their demand deposit account, to a card, etc., allowing immediate access to their funds.

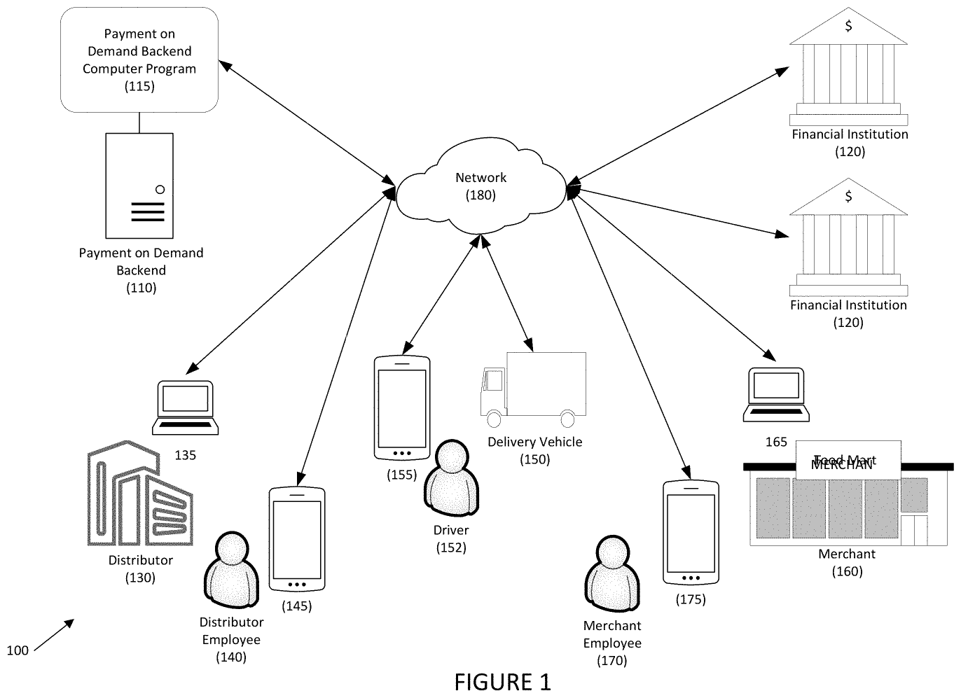

Referring to FIG. 1, a system for real-time payment on delivery is illustrated according to an embodiment. System 100 may include payment on demand backend 110, which may be a server (e.g., physical server, cloud-based server, etc.) that may execute payment on demand computer program 115. Payment on demand computer program 115 may interface with network 180, which may be any suitable computer network, including the Internet, cellular networks, WiFi networks, combinations thereof, etc.

System 100 may include one or more financial institution 120, which may hold accounts for distributor 130 and/or merchant 160. In one embodiment, one financial institution 120 may hold the account for distributor 130, and another financial institution 120 may hold the account for merchant 160.

In one embodiment, financial institutions 120 may communicate via a separate communication network, such as the Liink network.

Distributor 130 may be a provider of goods or services to merchant 160. For example, distributor 130 may maintain an inventory of goods that merchant 160 may order and that may be delivered by driver 152 and delivery vehicle 150. Distributor 130 may include computer system 135 that may interface with payment on demand backend computer program 115 via network 180. Distributor 130 may further employ one or more employees 140, which may interface with payment on demand backend computer program 115 using electronic device 145 and via network 180. In one embodiment, computer system 135 and/or electronic device 145 may execute a computer program or application that may provide distributor-specific services to distributor 130 and distributor employee 140, respectively, such as inventory management, delivery vehicle tracking, delivery vehicle routing, banking transactions, etc.

Driver 152 may use delivery vehicle 150 to deliver goods or services to merchant 160. In one embodiment, delivery vehicle 150 may interface with payment on demand backend computer program 115 using one or more vehicle systems, such as a vehicle navigation system, for tracking a location of delivery vehicle 150.

In one embodiment, driver 152 may interface with payment on demand backend computer program 115 using electronic device 155.

Merchant 160 may be a recipient of a good or service from distributor 130. In one embodiment, merchant 160 may include computer system 165 that may interface with payment on demand backend computer program 115 via network 180. Merchant 160 may further employ one or more employees 170, which may interface with payment on demand backend computer program 115 using electronic device 175 and via network 180. In one embodiment, computer system 165 and/or electronic device 175 may execute a computer program or application that may provide merchant-specific services to merchant 160 and merchant employee 170, respectively, such as good/service ordering, payment services, delivery vehicle tracking, etc.

In one embodiment, merchant 160 may be an individual.

Merchant 160 may have a digital wallet that may be accessible via computer system 165 and/or electronic device 175. In one embodiment, the digital wallet may be from a third party (e.g., PayPal, Square, etc.), from financial institution 120, etc. In one embodiment, the digital wallet may be required to be funded with a minimum amount of funds, which guarantees that distributor 130 will be paid. In one embodiment, the minimum amount may be determined using a trained machine-learning model based on transaction history, season, week, day, and any other factors as is necessary and/or desired. The digital wallet may be connected to merchant 160's bank account with financial institution 120 for transfer of funds to and from the digital wallet. In embodiment, the digital wallet may provide payment via any suitable payment mechanism, including, for example, the RTP network.

In one embodiment, the digital wallet may be maintained on a distributed ledger network, and payments may be digital payments from one digital wallet to another.

In one embodiment, the computer program or application executed by computer system 165 and/or electronic device 175 may provide a virtual assistant that may provide support for daily queries, chat functionality, etc. The virtual assistant may further use a trained machine-learning model to recommend new products based on merchant 160's order history, to notify merchant 160 when to re-stock certain products, to recommend order changes based on, for example, market demand/activity (e.g., order more beer before a major sporting event, be aware of any shortages based on climate events), staleness of inventory, etc., push discounts/notifications from the distributor to the merchant, etc.

In embodiments, merchant 160 may further include “smart” devices, such as Internet of Things (IoT) appliances, that may interface with computer system 165 and/or electronic device 175, or with distributor computer system 135 directly. In one embodiment, the smart devices may communicate order information (e.g., a refrigerator detects there is low volume of eggs) to computer system 165 and/or electronic device 175 for ordering, or may submit the order directly to merchant 160.

In one embodiment, distributor 130 and distributor employee 140, driver 152, and merchant 160 and merchant employee 170 may each provided with different applications to access on their respective devices. For example, there may be a distributor-side application, a driver-side application, and a merchant-side application that may provide the respective entities different functionality, different views, etc. For example, the distributor-side application may track delivery vehicle 150 at all times, while the merchant-side application may only track delivery vehicle 150 when it is in route to merchant 160. As another example, the distributor-side application may provide inventory services to distributor 130, while the merchant-side application does not provide that functionality. Driver-side application may provide driver 152 with directions, merchant details, payment information, the ability to modify an order, etc. In one embodiment, the merchant application may have access to a marketplace including a plurality of distributors 130. Thus, merchant 160 may see other distributors 130 that participate in system 100.

In embodiments, distributor 130 may configure an interface for merchant 160 that may be using accessed computer system 165 and/or electronic device 175. For example, distributor may provide an interface or application that may provide a look and feel that is similar to an in-person experience with distributor 130. In embodiments, the distributor may customize the interface or application through non-code development functionality.

In one embodiment, distributor 130 may provide distributor employee 140 or driver 152 with a financial instrument that may be connected to the distributor program or application that may be used to pay for expenses, such as fuel. Distributor 130 may integrate its expensing system to automatically reconcile any such expenses.

In embodiments, any of the application may employ machine learning to proactively interact with the respective entity. For example, the merchant application may train a machine learning model based on a history of goods or services ordered from the distributor, and the trained machine learning model add items and/or suggest items to purchase. The distributor application may train a machine learning model based on its history of transactions, and the trained machine learning model may automatically reorder or suggest reordering certain items.

Network 180 may include one or more communication network, payment network, etc. In one embodiment, network 180 may facilitate communication between payment on demand backend 110, financial institution 120, computer system 135, electronic device 145, electronic device 155, delivery vehicle 150, computer system 165, and/or electronic device 175.

Examples of suitable payment networks include the REAL TIME PAYMENT network and the FED NOW payment network.

In one embodiment, payment on demand backend computer program 115 may provide image-based damage estimation for merchant 160 and/or distributor 130. For example, if a product is damaged, merchant 160 may take a picture of the damaged product using, for example, the computer program or application executed by computer system 165 and/or electronic device 175. Using a trained machine learning engine, payment on demand backend computer program 115 may verify that the product is damaged, that the product is covered by warranty, and/or may generate an estimated refund due to the damage. In one embodiment, payment on demand backend computer program 115 may provide the estimated refund to merchant 160 for approval. In another embodiment, the refund may be automatically processed based distributor 130's settings (e.g., below a threshold amount).

In embodiments, payment on demand backend computer program 115 may be integrated with different Enterprise Resource Planning (ERP) systems, banking portals, etc.

In embodiments, payment on demand backend computer program 115 may integrate with distributor 130's payment terminal. For example, when delivery of the goods/services is complete and the merchant pays by, for example, credit card using a payment terminal (e.g., point of sale device, mobile point of sale device, etc.), the payment terminal may communicate payment to payment on demand backend computer program 115, which may automatically reconcile the payment with the invoice without merchant 160 having provide additional information.

In embodiments, payment on demand backend computer program 115 may provide onboarding for one or more of distributor 130, financial institution(s) 120, and merchant 160. In one embodiment, onboarding, which may include the execution of legal agreements, may be performed by one or more smart contracts. For example, the smart contract(s) may be executed on a distributed ledger network, such as Liink. In on embodiment, a penalty may be automatically incurred in response to a breach of contract.

In one embodiment, the smart contract(s) may ensure that distributor 130 is paid the full amount that is due. If sufficient funds are not available, the smart contract(s) may contact distributor 130 and/or driver 152 to postpone delivery, or may place a hold on the funds in the merchant digital wallet so that the merchant cannot withdraw funds until the invoice is paid in full.

In one embodiment, payment on demand backend computer program 115 may provide cross-border and/or foreign exchange payments. For example, payments may be executed for foreign merchants 160 and the payment may be converted to distributor 130's currency as needed. In embodiments, payment on demand backend computer program 115 may leverage a trained machine learning model and/or historical data analysis to predict the foreign exchange rate to ensure that distributor 130 and/or merchant 160 is receiving the best rate.

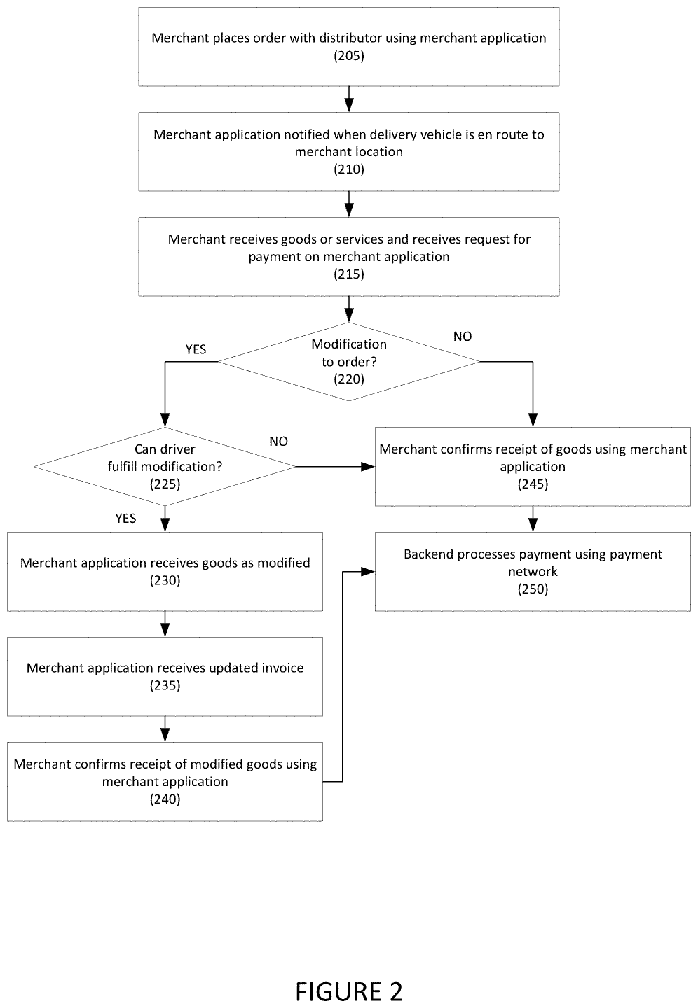

Referring to FIG. 2, a method for real-time payment on delivery is illustrated according to an embodiment.

In step 205, a merchant, using a merchant application on an electronic device may place an order with a distributor. For example, the computing device may be a mobile electronic device or similar.

In one embodiment, the order may be a standing order, a one-time order, etc.

In one embodiment, the good or service may be any suitable good or service. For example, the merchant may be a retailer, and the goods that the merchant is ordering may be for resale. In another embodiment, the merchant may be a consumer, and the goods or services may be consumed by the merchant. Any suitable arrangement may be used as is necessary and/or desired.

In one embodiment, the merchant may include an individual merchant, an individual consumer, a business, etc.

In step 210, the merchant application may receive a notification when the merchant application notified when delivery vehicle is en route to merchant location. For example, the merchant application may receive a notification from a backend, such as a payment on demand backend, that may monitor a location of the merchant's delivery service, such as a delivery vehicle.

In step 215, the merchant may receive the goods or services, and the merchant application may receive a request for payment. In one embodiment, the request for payment may be received from the payment on demand backend.

In step 220, the merchant may have a modification for the order. For example, using the merchant application, the merchant may submit a request for fewer of a good or service that were delivered, or may request more a good or service that was delivered, or may request a good or service that was not part of the order. If the merchant does have a modification, in step 225, the merchant application may submit the modification to the payment on demand backend, which may decision the modification, based on, for example, supplies on the delivery vehicle, distributor policies, etc. If the merchant application receives approval, in step 230, the merchant may receive the goods, as modified. In step 235, the merchant application may receive an updated invoice for the modified goods, and in step 240, using the merchant application, the merchant may confirm receipt of the modified goods.

If, in step 225, the merchant application receives rejection of the modified goods, in step 245, using the merchant application, the merchant may confirm receipt of the goods.

In step 250, the payment on demand backend may process the payment using a desired financial instrument and/or payment network, and may provide the merchant application with a receipt. In one embodiment, the merchant may have a registered payment account (e.g., credit card, financial account, etc.) with the payment on demand backend, and payment on demand backend may complete the transaction using that account.

In one embodiment, the payment may be competed using any suitable payment network, including the REAL-TIME PAYMENTS network, the FED NOW payment network, the Automated Clearing House (ACH) network, credit card payment networks, etc.

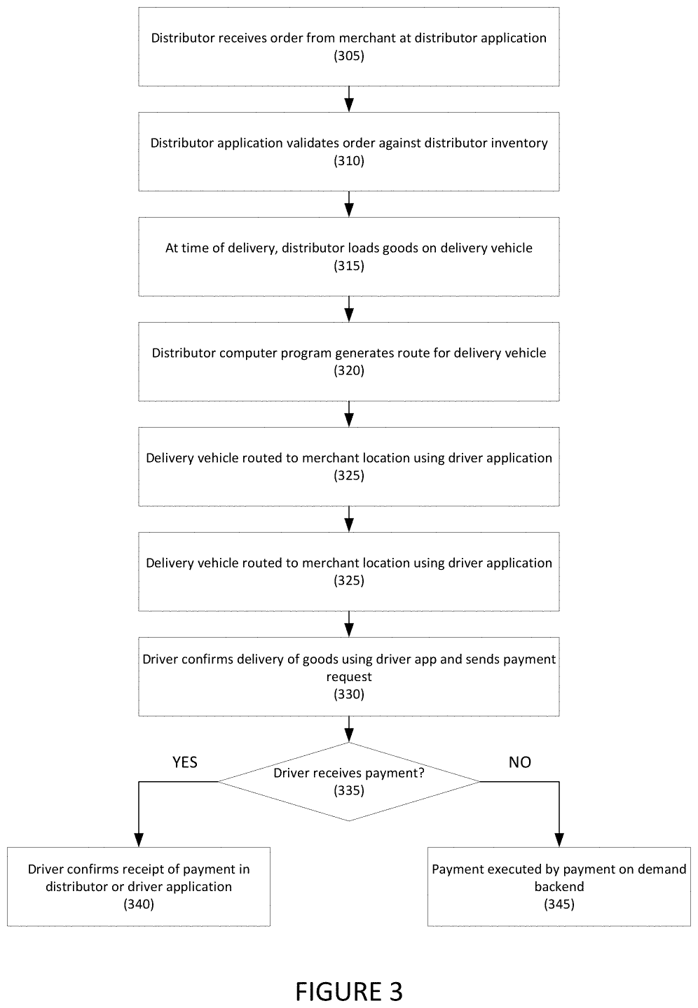

Referring to FIG. 3, a method for real-time payment on delivery is illustrated according to another embodiment. In step 305, a distributor, using a distributor computer application, may receive an order from a merchant. In one embodiment, the order may be a standing order, a one-time order, etc.

In step 310, the distributor application may validate the order against the distributor's application. If the distributor does not have sufficient inventory, the distributor application may reject the order, may modify the order, or may order sufficient goods to fulfil the order.

In step 315, the distributor application may instruct the distributor and/or the distributor's delivery service to prepare the goods for delivery. For example, the goods may be loaded on a delivery vehicle.

In step 320, the distributor computer program may generate a route for the delivery vehicle. For example, the distributor computer program may prepare an order for a plurality of deliveries and may optimize the route. For example, the route may be optimized to minimize time, minimize distance, minimize backtracking, minimize time in traffic, etc. Any suitable optimization may be used as is necessary and/or desired.

In one embodiment, if a separate driver application is used, the driver application may generate the route, or may receive the route from the distributor application.

In step 325, the distributor application may route the driver to the merchant's location. As noted above, if a separate driver application is provided, the driver application may route the driver to merchant location.

In one embodiment, while en route, the distributor application may receive a modification to the merchant order if, for example, the payment on demand backend confirms that the modification is acceptable. If the modification is acceptable, the distributor application may receive an updated order.

As noted above, if a separate driver application is provided, the driver application may receive the updated order.

In step 330, after delivering the goods, using the distributor application or the driver application, the driver may confirm delivery of the goods. In one embodiment, the distributor application and/or the driver application may confirm the delivery with the payment on demand backend.

In step 335, the driver may optionally receive payment from the merchant. For example, the merchant may provide payment by credit card, check, cash, etc. instead of using the payment on demand service.

If the driver receives payment, in step 340, using the distributor application or the driver application, the driver may confirm receipt of payment. In one embodiment, the driver may submit an image of the check, which may be deposited in the distributor application or driver application.

If the driver does not receive payment, for example, if the merchant has the payment on delivery backend complete payment, in step 345, the payment on delivery payment may execute payment.

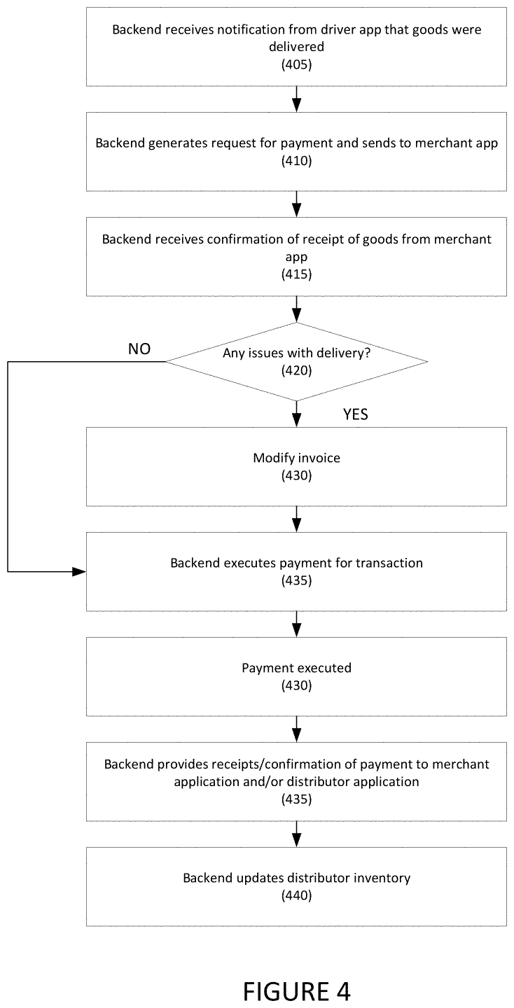

Referring to FIG. 4, a method for real-time payment on delivery is illustrated according to another embodiment.

In step 405, a payment on demand computer program executed by a backend may receive a notification that goods or services were delivered to a merchant. In one embodiment, the notification may be received from a driver application or a distributor application.

In step 410, the payment on demand computer program may generate a request for payment for the merchant and may communicate the request to a merchant application.

In step 415, the payment on demand computer program may receive confirmation from the merchant, via the merchant application, that the goods or services were delivered.

If, in step 420, there are any issues (e.g., wrong goods, wrong number, damaged goods, etc.) with the delivery, in step 430, the payment on demand computer program may modify the invoice to reflect the issuer.

In step 435, the payment on demand computer program may execute a transaction from the merchant account to the distributor account. This may be using

[symbol]

In step 430, the payment on demand backend may process the execute payment for the transaction. In one embodiment, the payment on demand backend may use a desired financial instrument (e.g., credit card, financial account, etc.) and/or payment network, including the REAL-TIME PAYMENTS network, the FED NOW payment network, the Automated Clearing House (ACH) network, credit card payment networks, etc.

In step 435, the payment on demand backend may provide receipts and/or confirmation of payment to the merchant application and/or the distributor application.

In step 440, the payment on demand backend may update the distributors inventory, re-order products, etc.

Although several embodiments have been disclosed, it should be recognized that these embodiments are not exclusive to each other, and certain elements or features from one embodiment may be used with another.

Hereinafter, general aspects of implementation of the systems and methods of the invention will be described.

The system of the invention or portions of the system of the invention may be in the form of a “processing machine,” such as a general-purpose computer, a quantum computing device, a quantum computing device simulator, etc. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system. Thus, embodiments of the invention may include a processing machine running the iOS operating system, the OS X operating system, the Android operating system, the Microsoft Windows™ operating systems, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for real-time payment on delivery, comprising:
receiving, at a merchant computer program executed by a merchant electronic device associated with a merchant, an order for a good to be submitted to a distributor;
communicating, to a payment on demand computer program executed by a backend, the order;
receiving, at the merchant computer program and from the payment on demand computer program, a notification that a delivery vehicle for the good is en route to a location for the merchant;
receiving, at the merchant computer program and from the payment on demand computer program, a request for payment for the good after the good is delivered, wherein the distributor confirms delivery with the payment on demand computer program; and
communicating, by the merchant computer program and to the payment on demand computer program, receipt of the good from the distributor;
wherein the payment on demand computer program executes payment for the good from a merchant account to a distributor account.

2. The method of claim 1, wherein the order is a one-time order.

3. The method of claim 1, wherein the order is a standing order.

4. The method of claim 1, further comprising:
communicating, by the merchant computer program and to the payment on demand computer program, a modification the order after receiving the notification that the delivery vehicle is en route;
wherein the payment on demand computer program verifies that the distributor can meet the modification; and
wherein the payment on demand computer program modifies an invoice based on the modification and communicates the modified invoice to the merchant computer program after receiving confirmation of delivery.

5. The method of claim 1, wherein the payment is executed using a payment on demand payment network.

6. The method of claim 1, wherein the merchant account has a minimum funding requirement, and the payment on demand computer program verifies that the merchant account meets the minimum funding requirement before the delivery vehicle is en route to the location for the merchant.

7. A method for real-time payment on delivery, comprising:
receiving, at a distributor computer program executed by a distributor electronic device and from a payment on demand computer program executed by a backend, an order for a good from a merchant computer program associated with a merchant;
validating, by the distributor computer program, the order against a distributor inventory of the good;
receiving, at the distributor computer program and from the payment on demand computer program, an instruction to prepare the good for delivery;
generating, by the distributor computer program, a route for a delivery vehicle carrying the good;
receiving, at the distributor computer program, a confirmation of delivery of the good; and
communicating, by the distributor computer program and to the payment on demand computer program, the confirmation of delivery.

8. The method of claim 7, further comprising:
receiving, by the distributor computer program, a payment from the merchant; and
communicating, by the distributor computer program and to the payment on demand computer program, the payment.

9. The method of claim 7, wherein the step of generating, by the distributor computer program, a route for a delivery vehicle carrying the good comprises:
optimizing, by the distributor computer program, the route to minimize at least one of time, distance, backtracking, time in traffic.

10. The method of claim 7, further comprising:
receiving, by the distributor computer program and from the payment on demand computer program, a modification to the order;
wherein the distributor computer program communicates confirmation of delivery of the modified order to the payment on demand computer program.

11. The method of claim 7, further comprising:
sending, by the distributor computer program, the route to a driver computer program executed by a driver electronic device or the delivery vehicle.

12. The method of claim 7, further comprising:
receiving, by the distributor computer program, an indication of payment from the merchant; and
communicating, by the distributor computer program, the indication of payment to the payment to the payment on demand computer program.

13. The method of claim 12, wherein the indication of payment comprises a credit card payment.

14. The method of claim 12, wherein the indication of payment comprises an image of a check.

15. A method for real-time payment on delivery, comprising:
receiving, at a payment on demand computer program executed by a backend, a delivery notification from a distributor computer application for a distributor or a driver computer application for a driver indicating that a good was delivered to a merchant;
generating, by the payment on demand computer program, a request for payment from the merchant;
communicating, by the payment on demand computer program, the request for payment to a merchant computer application for the merchant;
receiving, from the merchant computer application, confirmation of payment; and
causing, by the payment on demand computer program, the payment to be executed from a merchant account to a distributor account.

16. The method of claim 15, wherein the payment is executed using a payment on demand payment network.

17. The method of claim 15, wherein the merchant account has a minimum funding requirement, and the payment on demand computer program verifies that the merchant account meets the minimum funding requirement.

18. The method of claim 15, further comprising:
receiving, by the payment on demand computer program, an indication that the good was unacceptable;
generating, by the payment on demand computer program, a discount or refund for the unacceptable good; and
crediting, by the payment on demand computer program, an account for the merchant with the discount or refund.

19. The method of claim 18, wherein the indication that the good was unacceptable comprises an image of the good, and the discount or refund is based on an assessment provided by trained machine-learning model.

20. The method of claim 15, further comprising:
updating, by the payment on demand computer program, an inventory for the distributor following delivery.
